(19) United States
(12) Patent Application Publication
(10) Pub. No.: US 2025/0063632 A1
(43) Pub. Date: Feb. 20, 2025

(54) OPERATIONS ON TA TIMER EXPIRATION IN MULTI-TA FOR MDCI MTRP

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/721,595

(22) PCT Filed: Feb. 23, 2022
(86) PCT No.: PCT/CN2022/077362

§ 371 Date: Jun. 18, 2024

(51) Int. Cl. H04W 76/38; H04W 72/11

(52) U.S. Cl. CPC H04W 76/38; H04W 72/11

(57) ABSTRACT

Apparatus, methods, and computer program products for performing operations based on TA timer expiration are provided. An example method may include receiving, from a network entity, a first TAG configuration associated with a first TRP associated with the network entity. The example method may further include receiving, from the network entity, a second TAG configuration associated with a second TRP associated with the network entity, the first TAG configuration and the second TAG configuration being associated with a BWP or a CC, the first TAG configuration being associated with a first time alignment timer and the second TAG configuration being associated with a second time alignment timer. The example method may further include performing one or more timer expiration operations for a serving cell based on at least one of the first time alignment timer or the second time alignment timer.

### TECHNICAL FIELD

The present disclosure relates generally to communication systems, and more particularly, to wireless communication systems with timing advance (TA) timer expiration operations.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. The memory and the at least one processor coupled to the memory may be configured to receive, from a network entity, a first timing advance (TA) group (TAG) configuration associated with a first transmission reception point (TRP) associated with the network entity. The memory and the at least one processor coupled to the memory may be further configured to receive, from the network entity, a second TAG configuration associated with a second TRP associated with the network entity, the first TAG configuration and the second TAG configuration being associated with a bandwidth part (BWP) or a component carrier (CC), the first TAG configuration being associated with a first time alignment timer and the second TAG configuration being associated with a second time alignment timer. The memory and the at least one processor coupled to the memory may be further configured to perform one or more timer expiration operations for a serving cell based on at least one of the first time alignment timer or the second time alignment timer.

In an aspect of the disclosure, a method, a computer-readable medium, and an apparatus at a network entity are provided. The apparatus may include a memory and at least one processor coupled to the memory. The memory and the at least one processor coupled to the memory may be configured to transmit a first timing advance (TA) group (TAG) configuration associated with a first transmission reception point (TRP) associated with the network entity. The memory and the at least one processor coupled to the memory may be further configured to transmit a second TAG configuration associated with a second TRP associated with the network entity, the first TAG configuration and the second TAG configuration being associated with a bandwidth part (BWP) or a component carrier (CC), the first TAG configuration being associated with a first time alignment timer and the second TAG configuration being associated with a second time alignment timer, where at least one of the first time alignment timer or the second time alignment timer is associated with one or more timer expiration operations for a serving cell.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A is a diagram illustrating example communications between a UE and two TRPs.

FIG. 4B is a diagram illustrating example TA.

FIG. 5A is a diagram illustrating single downlink (DL) timing or separate DL timing.

FIG. 5B is a diagram illustrating single downlink (DL) timing or separate DL timing.

FIG. 6 is a diagram illustrating example communications between a network entity and a UE.

FIG. 7 is a diagram illustrating example associations of timing advance group (TAG) with unified transmission configuration indicator (TCI).

FIG. 8 is a diagram illustrating example communications between a network entity and a UE.

FIG. 9 is a diagram illustrating example time alignment timer communications in multi-TAG.

FIG. 10 is a flowchart of a method of wireless communication.

FIG. 11 is a flowchart of a method of wireless communication.

FIG. 12 is a diagram illustrating an example of a hardware implementation for an example apparatus.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

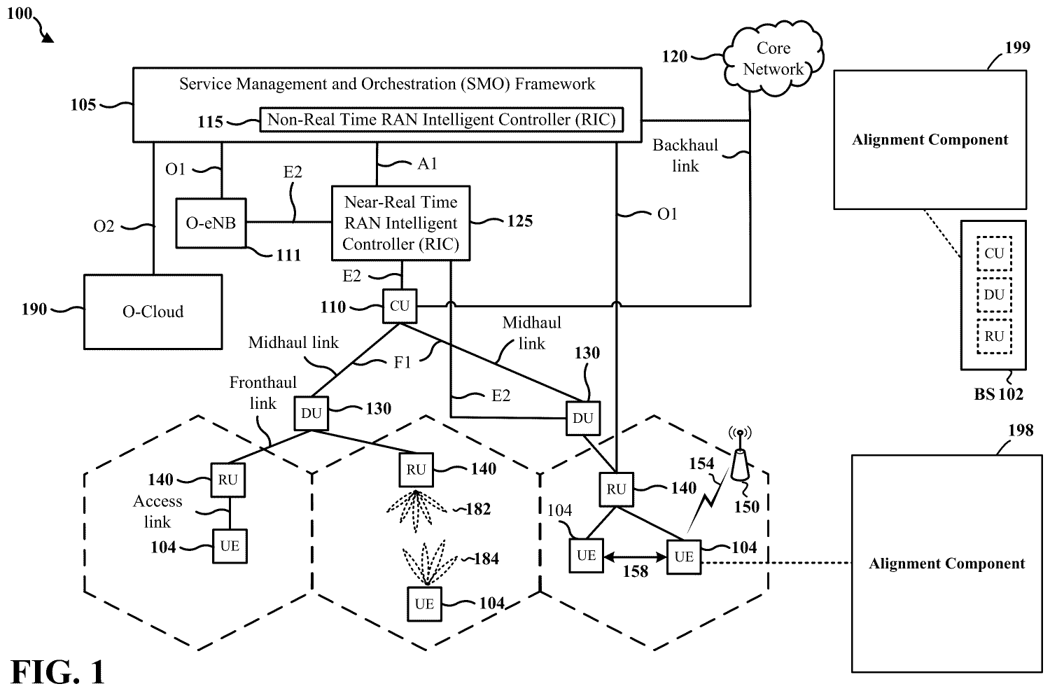

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs (also referred to as Wi-Fi stations (STAs)) 104 via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include an alignment component 198. In some aspects, the alignment component 198 may be configured to receive, from a network entity, a first timing advance (TA) group (TAG) configuration associated with a first transmission reception point (TRP) associated with the network entity. In some aspects, the alignment component 198 may be further configured to receive, from the network entity, a second TAG configuration associated with a second TRP associated with the network entity, the first TAG configuration and the second TAG configuration being associated with a bandwidth part (BWP) or a component carrier (CC), the first TAG configuration being associated with a first time alignment timer and the second TAG configuration being associated with a second time alignment timer. In some aspects, the alignment component 198 may be further configured to perform one or more timer expiration operations for a serving cell based on at least one of the first time alignment timer or the second time alignment timer.

In certain aspects, the base station 102 may include an alignment component 199. In some aspects, the alignment component 199 may be configured to transmit a first timing advance (TA) group (TAG) configuration associated with a first transmission reception point (TRP) associated with the network entity. In some aspects, the alignment component 199 may be further configured to transmit a second TAG configuration associated with a second TRP associated with the network entity, the first TAG configuration and the second TAG configuration being associated with a bandwidth part (BWP) or a component carrier (CC), the first TAG configuration being associated with a first time alignment timer and the second TAG configuration being associated with a second time alignment timer. In some aspects, at least one of the first time alignment timer or the second time alignment timer is associated with one or more timer expiration operations for a serving cell.

Although the following description may be focused on 5G NR, the concepts described herein may be applicable to other similar areas, such as LTE, LTE-A, CDMA, GSM, and other wireless technologies.

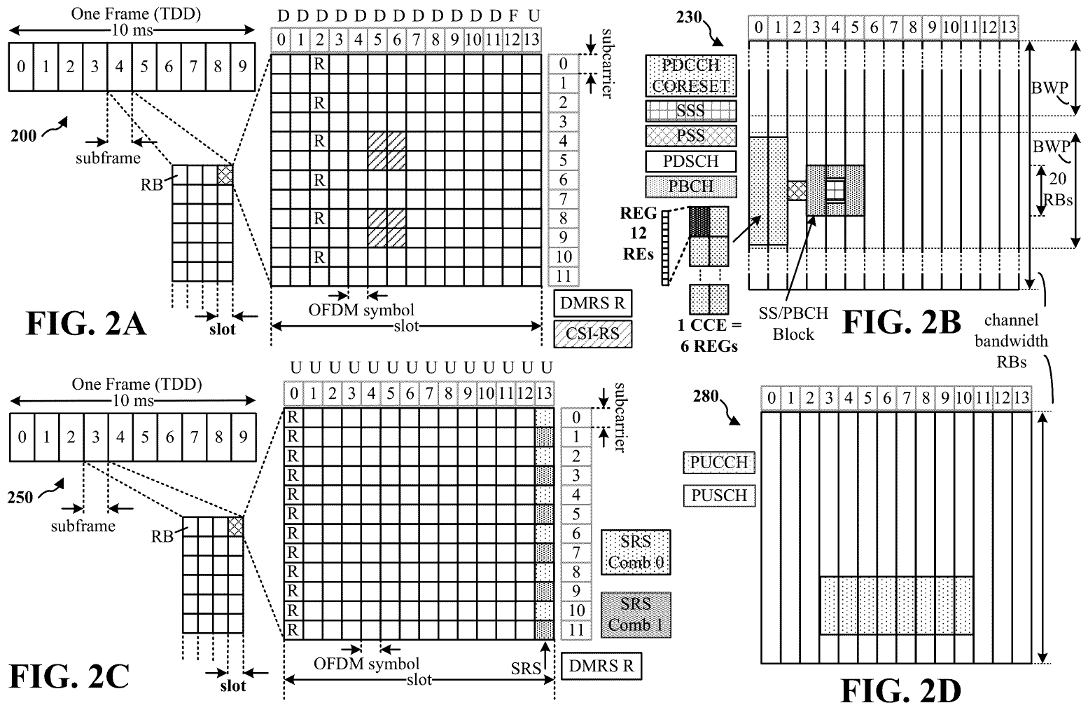

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

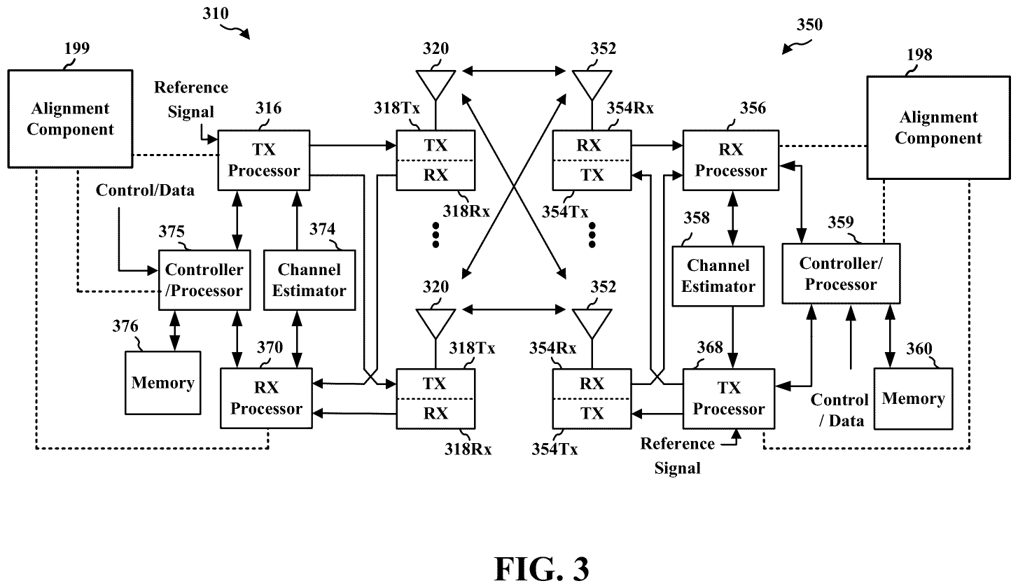

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with alignment component 198 of FIG. 1.

At least one of the TX processor 316, the RX processor 370, and the controller/processor 375 may be configured to perform aspects in connection with alignment component 199 of FIG. 1.

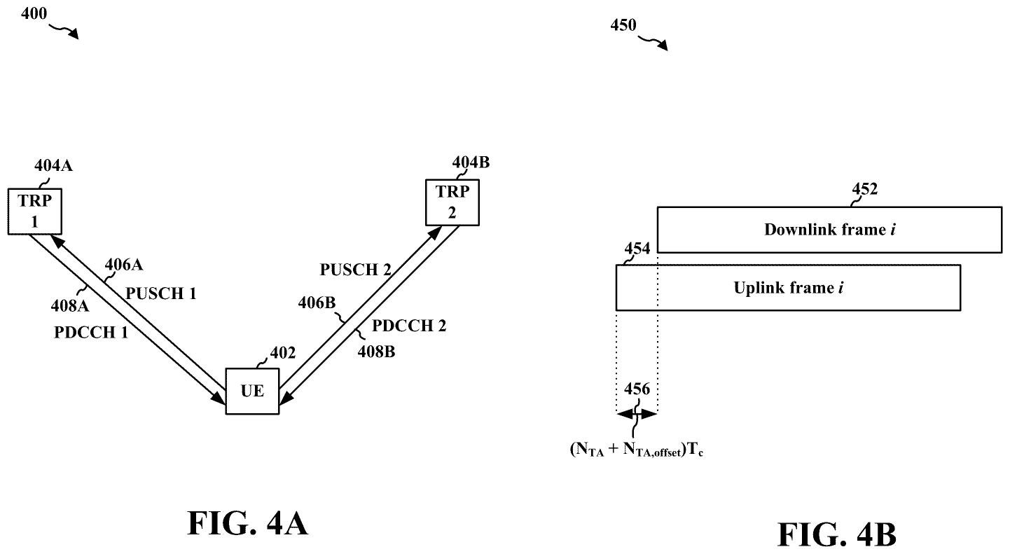

FIG. 4A is a diagram 400 illustrating example communications between a UE and two TRPs. As illustrated in FIG. 4A, a UE 402 may be simultaneously connected to a first TRP 404A and a second TRP 404B. In some aspects, the UE 402 may receive a first PDCCH 408A from the first TRP 404A. The UE 402 may also transmit a first PUSCH 406A to the first TRP 404A. In some aspects, the UE 402 may receive a second PDCCH 408B from the second TRP 404B. The UE 402 may also transmit a second PUSCH 406B to the second TRP 404B.

A UE may transmit an UL signal to a base station or a TRP. The UL signal may take a length of time to reach the destination base station or the TRP because the signal may travel from the UE to the destination base station or TRP for a length of time. Therefore, to meet a defined arrival time (e.g., defined based on slots or other units) in a wireless communication system, a UE in the wireless communication system may transmit UL signals based on a TA. As one example, the UE may transmit an UL signal a length of time before the defined arrival time based on a TA, which may be based on a distance between the UE and the TRP. FIG. 4B is a diagram 450 illustrating example TA. As illustrated in FIG. 4B, a DL frame of frame number i 452 and an associated UL frame of frame number i 454 may be transmitted on a RF carrier. The UL frame of frame number i 454 may start in advance of the DL frame of frame number i 452 by a TA 456 that may be equal to (N_{TA}+N_{TA,offset})T_{c}. The parameter T_{c} may represent a basic time unit, such as a one-bit period (e.g., approximately 3.69 microseconds). The parameter N_{TA,offset} may represent a TA defined based on a frequency band. The parameter N_{TA} may represent a TA that may be defined or signaled based on a location of the UE and the TRP or base station.

By way of example, in some wireless communication systems, the TA may be a value between 0 and 63, with each step between 0 and 63 representing an advance of one-bit period (e.g., approximately 3.69 microseconds). With signals (radio waves) travelling at about 300,000,000 meters per second (i.e., 300 meters per microsecond), one TA step then represents a change in round-trip distance (twice the propagation range) of approximately 1,100 meters. Therefore, in such an example, the TA may change for each 550-meter change in the range between the UE and the TRP/base station.

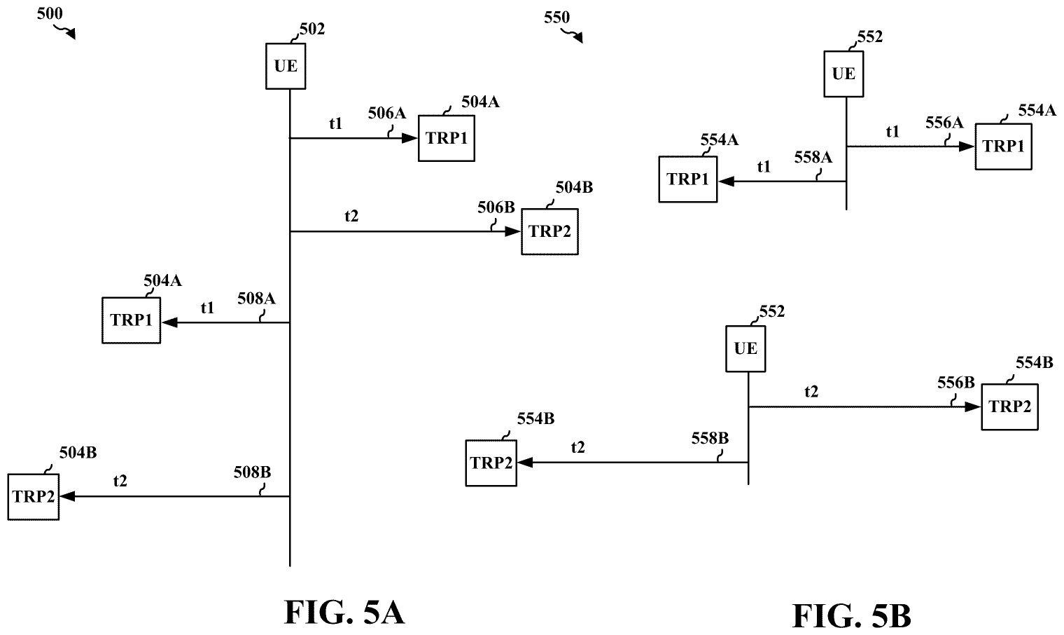

Because TA may be based on a location of the TRP, in mTRP operations, two TAs may be defined for UL transmissions. For example, two TAs may be defined for UL multi-DCI for mTRP operation with two TRPs, a first TRP and a second TRP. FIGS. 5A-5B are diagrams 500 and 550 illustrating single DL timing or separate DL timing. As illustrated in FIG. 5A, in single DL timing, a UE 502 transmit a transmission 506A to a first TRP 504A based on a first TA. In a same channel, the UE 502 may also transmit a transmission 506B to a second TRP 504B based on a second TA. The UE 502 may also transmit another transmission 508A to the first TRP 504A based on the first TA and transmit another transmission 508B to the second TRP 504B based on the second TA in a same channel.

As illustrated in FIG. 5B, in separate DL timing, a UE 552 may transmit a transmission 556A to a first TRP 554A based on a first TA. In the same channel at another time, the UE 552 may transmit another transmission 558A to the first TRP 554A based on the first TA. In a separate channel, the UE 552 may transmit a transmission 556B to a second TRP 554B based on a second TA. In the separate channel at another time, the UE 552 may transmit another transmission 558B to the second TRP 554B based on the second TA.

In some wireless communication systems, TA configuration may be multi-cell and BWP common while mTRP configurations may be CC or BWP specific. Example configurations are provided below:

```
ServingCellConfig ::= SEQUENCE {
  tag-Id, TAG-Id
  downlinkBWP-ToReleaseList
  downlinkBWP-ToAddModList
  ...
}
BWP-DownlinkDedicated ::= SEQUENCE {
  pdcch-Config
  ...
}
PDCCH-Config ::= SEQUENCE {
  controlResourceSetToAddModList-r16
  controlResourceSetToReleaseList-r16
  ...
}
ControlResourceSet ::= SEQUENCE {  coresetPoolIndex-r16
INTEGER
(0..1)
  controlResourceSetId-r16
  ...
}
```

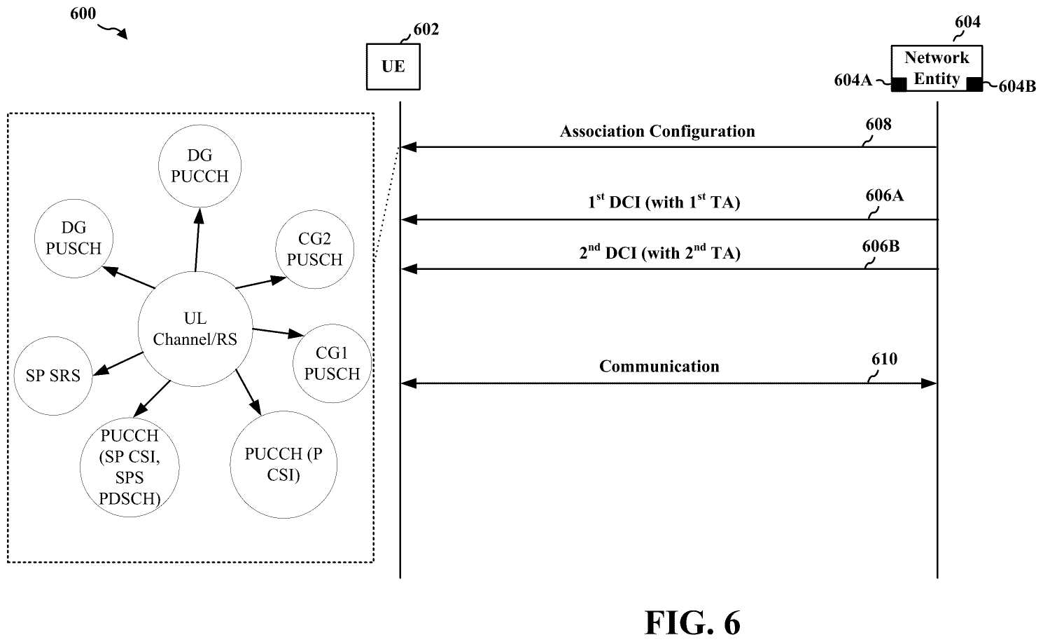

As previously described, in an information element (IE) for serving cell configuration (ServingCellConfig), IEs for TAG IDs, a list of BWP configurations of type BWP downlink (downlinkBWP-ToAddModList), and a list of BWPs to be released (downlinkBWP-ToReleaseList) may be included. The list of BWP configurations of type BWP downlink (downlinkBWP-ToAddModList) may correspond with a configuration for configuring the dedicated (UE specific) parameters of a downlink BWP (BWP-DownlinkDedicated). The configuration for configuring the dedicated (UE specific) parameters of a downlink BWP (BWP-DownlinkDedicated) may include a PDCCH configuration (pdcch-Config). The PDCCH configuration (pdcch-Config) may include a list of UE specifically configured Control Resource Sets (CORESETs) to be used by the UE (controlResourceSetToAddModList-r16) and a list of CORESETs to be released by the UE (controlResourceSetToReleaseList-r16). A list of CORESETs may be represented in an IE (ControlResourceSet) that may include a CORESET pool index (coresetPoolIndex-r16) and associated CORESET identifier (ID) (controlResourceSetId-r16). The CORESET pool index of value 0 and 1 may be associated with the first TRP and the second TRP, respectively. FIG. 6 is a diagram 600 illustrating example communications between a network entity 604 and a UE 602. The network entity may be a network node. A network node may be implemented as an aggregated base station, as a disaggregated base station, an integrated access and backhaul (IAB) node, a relay node, a sidelink node, or the like. A network entity can be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC. In some aspects, the network entity 604 may include a first TRP 604A and a second TRP 604B.

The UE 602 may receive a first DCI 606A that may be associated with (e.g., indicate) a first TA from the network entity 604. In some aspects, the UE 602 may receive a second DCI 606B that may be associated with (e.g., indicate) a second TA from the network entity 604. The UE 602 and the network entity 604 may exchange communication 610 based on the first TA or the second TA. The first TA and the second TA may be associated with the configuration of the first TA group and the second TA group in the serving cell. In some aspects, the first TA and the second TA may be associated with different sets of UL channels. In some aspects, the first TA and the second TA may be associated with different sets of UL channels based on an association configuration defined without signaling. In some aspects, the first TA and the second TA may be associated with different sets of UL channels based on an association configuration 608 transmitted from the network entity 604 to the UE 602 before receiving the first DCI 606A and the second DCI 606B. As illustrated in FIG. 6, by way of example, the UL channels may include dynamic uplink transmissions, semi-persistent uplink transmissions, and periodical uplink transmissions. For example, the dynamic uplink transmissions may include dynamic grant (DG) PUSCH where the PUSCH is dynamically scheduled by a DCI, DG PUCCH where the PUCCH is dynamically transmitted in response to a DCI, and aperiodic SRS. For example, the semi-persistent uplink transmissions may include configured grant (CG) type 2 PUSCH (CG2-PUSCH) where the PUSCH may be activated by an activating DCI, PUCCH for semi-persistent channel state information (SP-CSI) report where the PUCCH is to transmit a semi-persistent CSI report, PUSCH for semi-persistent channel state information (SP-CSI) where the PUSCH is to transmit a semi-persistent CSI report, or PUCCH to semi-persistently transmit the acknowledgement for semi-persistent scheduling (SPS) PDSCH, semi-persistent sounding reference signal (SP SRS), or the like. For example, the periodical uplink transmissions may include configured grant (CG) PUSCH of type 1 where the PUSCH may be configured by RRC signaling, PUCCH with periodical channel state information (P-CSI) report where the PUCCH is to transmit a periodical CSI report, and periodical SRS.

In some aspects, to associate the first TA and the second TA with different sets of UL channels, a TAG may be associated with a CORESET pool index. For example, the first TAG may be associated with CORESET pool index 0, and the second TAG in the same CC may be associated with CORESET pool index 1. For different UL channel or RS, the association may be done by different signaling. For example, in some aspects, a scheduling DCI, e.g., scheduling for a dynamic uplink transmission such as DG PUSCH or DG PUCCH, may associate a TAG with the CORESET pool index for the uplink transmissions. When the UE receives a DCI scheduling a dynamic uplink transmission such as PUSCH, SRS or PUCCH, the UE may determine the TA for the uplink transmission based on a CORESET pool index of the CORESET associated with the DCI. For example, when the UE receives a DCI scheduling a dynamic uplink transmission in a CORESET of a CORESET pool index 0 or of no CORESET pool index, the UE may determine a TA associated with the first TAG to be applied for the dynamic uplink transmission, and when the UE receives a DCI scheduling a dynamic uplink transmission in a CORESET of CORESET pool index 1, the UE may determine a TA associated with the second TAG to be applied for the dynamic uplink transmission. In some other examples, a DCI scheduling a dynamic uplink transmission may include a field to indicate which TA (or TAG ID (also referred to as TAG-Id)) or which CORESET pool index is applied for the uplink transmission.

In another example, in some aspects, an activating signaling, such as DCI or a medium access control (MAC) control element (CE) (MAC-CE), e.g., for a semi-persistent uplink transmission such as semi-persistent sounding reference signal (SP-SRS), configured grant (CG) two physical uplink shared channel (CG2-PUSCH), PUCCH or PUSCH for semi-persistent channel state information (SP-CSI) or PUCCH carrying acknowledgement for semi-persistent scheduling (SPS) PDSCH, may associate the TAG with the CORESET pool index for the semi-persistent uplink transmission. When the UE receives an activating DCI activating a semi-persistent uplink transmission, the UE may determine the TA for the uplink transmission based on a CORESE pool index of the CORESET associated with the activating DCI. For example, when the UE receives an activating DCI activating a semi-persistent uplink transmission in a CORESET of a CORESET pool index 0 or of no CORESET pool index, the UE may determine a TA associated with the first TAG to be applied for the semi-persistent uplink transmission, and when the UE receives an activating DCI activating a semi-persistent uplink transmission in a CORESET of a CORESET pool index 1, the UE may determine a TA associated with the second TAG to be applied for the semi-persistent uplink transmission. In some other examples, an activating DCI activating a semi-persistent uplink transmission may include a field to indicate which TA (or TAG ID) or which CORESET pool index is applied for the semi-persistent uplink transmission. The semi-persistent uplink transmission may include such as the PUSCH for SP-CSI report, or the CG PUSCH.

When the UE receives a MAC-CE activating a semi-persistent uplink transmission, the UE may determine the TA for the uplink transmission based on a CORESE pool index of the CORESET associated with the MAC-CE. For example, when the UE receives a MAC-CE activating a semi-persistent uplink transmission in a CORESET of CORESET pool index 0 or of no CORESET pool index, the UE may determine a TA associated with the first TAG to be applied for the semi-persistent uplink transmission, and when the UE receives a MAC-CE activating a semi-persistent uplink transmission in a CORESET of CORESET pool index 1, the UE may determine a TA associated with the second TAG to be applied for the semi-persistent uplink transmission. In some aspects, the CORESET associated with the MAC-CE may be determined based on a CORESET where the UE receives the DCI scheduling a PDSCH which carries the MAC-CE. In some aspects, the MAC-CE activating a semi-persistent uplink transmission may include a field to indicate which TA (or TAG ID) or which CORESET pool index is applied for the semi-persistent uplink transmission. The semi-persistent uplink transmission may include such as the PUCCH for SP-CSI report or the SP-SRS.

In some aspects, a higher layer configuration signaling, such as an RRC or MAC-CE signaling, may indicate which TA (or TAG ID) or which CORESET pool index is applied for the uplink transmission. For example, the RRC signaling configuring a periodical uplink transmission may include a field to indicate which TA (or TAG ID) or which CORESET pool index is applied to the periodical uplink transmission. The periodical uplink transmission may include such as the PUCCH for periodic channel state information (P-CSI) or the P-SRS.

In some aspects, to associate the first TA and the second TA with different sets of UL channels, a TAG may be associated with a close loop index (CLI) of UL channel or RS. In some aspects, the TA to be associated with an uplink channel or reference signal may be determined based on a CLI index included in the power control (PC) parameters indicated for the UL channel or RS. For example, in some aspects, a CLI index of 0 may be associated with a first TA (e.g., TA of lower TAG ID), and a CLI index of 1 may be associated with a second TA (e.g., TA of higher TAG ID). When the UE transmit an uplink channel with a CLI index of 0, the UE may determine the TA associated with the lower TAG-Id to be applied to the uplink channel, and when the UE transmit an uplink channel with a CLI index of 1, the UE may determine the TA associated with the higher TAG-Id to be applied to the uplink channel.

In some aspects, to associate the first TA and the second TA with different sets of UL channels, a TAG may be associated with a unified TCI or a unified TCI group. For example, each unified TCI or unified TCI group may be associated with a TAG, and different unified TCIs or different unified TCI groups may be associated with TAGs.

A TCI state may include quasi co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 4 TCI may be a separate DL single channel or RS TCI state to indicate a beam for a single DL channel or RS. A type 5 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for CQI management, a DM-RS associated with non-UE-dedicated reception on PDSCH and a subset (which may be a full set) of control resource sets (CORESETs), or the like. A TCI state may be defined to represent at least one source RS to provide a reference (e.g., UE assumption) for determining quasi-co-location (QCL) or spatial filters. For example, a TCI state may define a QCL assumption between a source RS and a target RS.

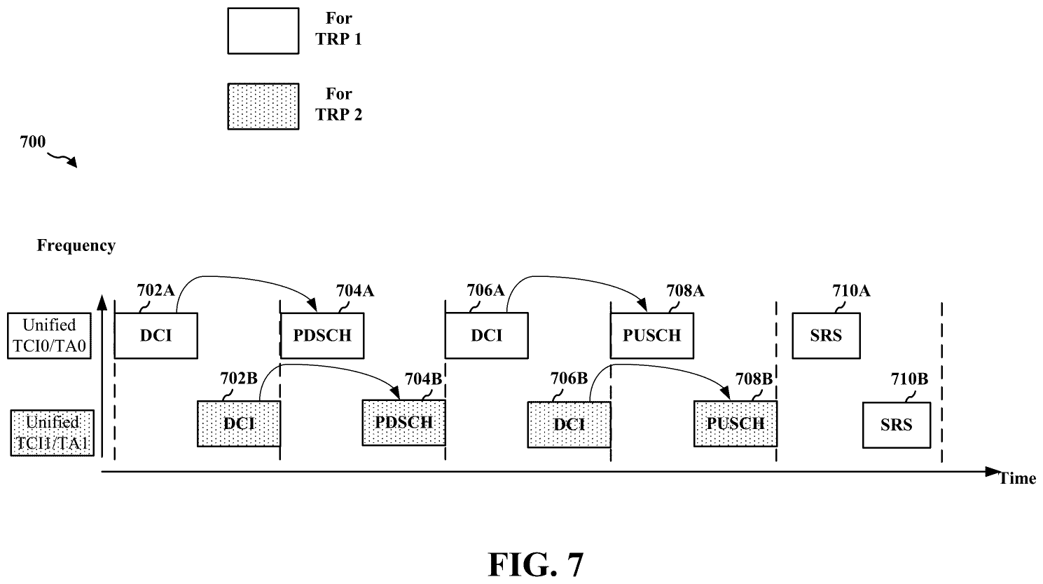

FIG. 7 is a diagram 700 illustrating example associations of TAG with unified TCI. In some aspects, TCIs with a root RS from serving-cell or non-serving cell may be associated with different TAs. For example, in some aspects, a first TCI with serving-cell SSB as a root QCL RS may be associated with a first TA (e.g., TA of lower TAG ID), and a second TCI with non-Serving-cell SSB as a root QCL RS may be associated with a second TA (e.g., TA of higher TAG ID). As another example, in some aspects, a first half of TCIs in TCI pool may be associated with a first TA (e.g., TA of lower TAG ID), and a second half of TCIs in TCI pool may be associated with the second TA (e.g., TA of higher TAG ID). In some aspects, the association indication may be included in TCI configuration, or TCI pool configuration, or TCI activation MAC-CE. As illustrated in FIG. 7, DCI 702A and associated PDSCH 704A may be transmitted based on the unified TCI 0, which may be associated with a first TA 0. A PUSCH 708A associated with DCI 706A may be transmitted based on the first TA 0 and an SRS 710A may also be transmitted based on the first TA 0. DCI 702B and associated PDSCH 704B may be transmitted based on the unified TCI 1, which may be associated with a second TA 1. A PUSCH 708B associated with DCI 706B may be transmitted based on the second TA 1 and an SRS 710B may also be transmitted based on the second TA 1.

In some aspects, if a single TA may be used without a second TA while two TAs may be configured for the UE 602, the UE 602 may determine one TA for a BWP, CC, or TRP. In some aspects, when the first UL BWP in a first CC involves an sTRP operation without another TRP, the UE 602 may be indicated with a TA command associated with the sTRP. The UE 602 may apply the related TA to the UL transmission for the single TRP based on the TA command.

In some aspects, when the UE 602 receives a second TA command associated with a second TRP for a second CC or BWP, the UE 602 may ignore the second TA command's application to the first CC or BWP. For example, the UE 602 may be configured with CORESET pool index 0 and 1 for CORESETs in BWP1 of CC1 and configured with CORESET pool index 1 for CORESETs in BWP2 of CC2. The UE 602 may be configured with two TAGs of Tag-Id0 and Tag-Id1 for both CC1 and CC2. In some aspects, the UE 602 may apply TA commands for Tag-Id0 and Tag-Id1 to BWP1 of CC1, and apply TA commands for Tag-Id1 to BWP2 of CC2.

In some aspects, the UE 602 may be configured with serving cell SSBs and non-serving cell SSBs as root QCL source RS for TCIs in BWP1 of CC1, and configured with serving cell SSBs as root QCL source RS for TCIs in BWP2 of CC2. In some aspects, the UE 602 may be configured with two TAG of Tag-Id0 and Tag-Id1 for CC1 and CC2. In some aspects, the UE 602 may apply TA commands for Tag-Id0 and Tag-Id1 to BWP1 or CC1, and apply TA commands for Tag-Id0 to BWP2 or CC2.

In some aspects, when a timing advance command MAC-CE is received, and if an N_{TA} has been maintained with the indicated TAG, the UE may apply the timing advance command for the indicated TAG. In some aspects, the timing advance command may be a command that enables the UE to adjust its uplink transmission. For example, referring back to FIG. 4B, the parameter N_{TA,offset} may be adjusted based on the timing advance command. In some aspects, the timing advance command MAC-CE may include a timing advance command field. In some aspects, the timing advance command field may include a number of bits (e.g., 6 bits) that represent a number of values of TA (e.g., 64 values of TA). As previously described, by way of example, in some wireless communication systems, the TA may be a value between 0 and 63, with each step between 0 and 63 representing an advance of one-bit period (e.g., approximately 3.69 microseconds). With signals (e.g., radio waves) travelling at about 300,000,000 meters per second (i.e., 300 meters per microsecond), one TA step may then represent a change in round-trip distance (i.e., twice the propagation range) of approximately 1,100 meters.

The UE may additionally start or restart a time alignment timer associated with the indicated TAG. In some aspects, the time alignment timer may be used for controlling how long the UE is considered to be UL time aligned. In some wireless communication systems, upon an expiration of the time alignment timer, the UE, such as a MAC entity at the UE, May 1) flush all HARQ buffers for all serving cells, 2) notify RRC to release a PUCCH for all serving cells, if configured, 3) notify RRC to release SRS for all serving cells, if configured, 4) clear configured downlink assignments and configured uplink grants, 5) clear a PUSCH resource for semi-persistent CSI reporting, and 6) maintain N_{TA}.

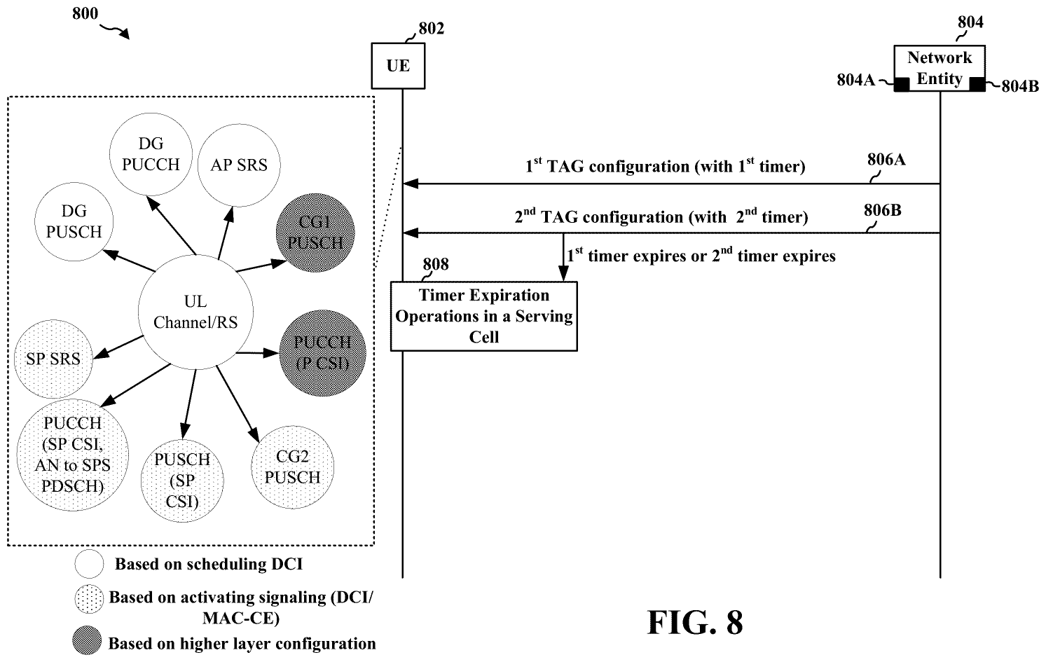

Aspects provided herein support time alignment timer operations in multi-DCI and mTRP. For example, aspects provided herein support time alignment timer operations when multiple TAGs (e.g., two TAGs) are configured with individual time alignment timers in a BWP or CC configured with multi-DCI and mTRP. FIG. 8 is a diagram 800 illustrating example communications between a network entity 804 and a UE 802. In some aspects, the UE 802 may correspond to the UE 602 and the network entity 804 may correspond to the network entity 604. In some aspects, the example communications illustrated in FIG. 8 may be exchanged in connection with the example communications illustrated in FIG. 6. The network entity 804 may be a network node. A network node may be implemented as an aggregated base station, a disaggregated base station, an integrated access and backhaul (IAB) node, a relay node, a sidelink node, or the like. A network entity can be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC. In some aspects, the network entity 804 may include a first TRP 804A and a second TRP 804B.

As illustrated in FIG. 8, the UE 802 may receive, from the network entity 804, a first TAG configuration 806A that may be associated with a first time alignment timer (e.g., associated with the TRP 804A). The UE 802 may also receive, from the network entity 804, a second TAG configuration 806B that may be associated with a second time alignment timer (e.g., associated with the TRP 804B). In some aspects, the first time alignment timer and the second time alignment timer may be configured for a BWP or CC configured with multi-DCI (e.g., the first DCI 606A and the second DCI 606B) and mTRP (e.g., the first TRP 804A and the second TRP 804B).

Referring back to FIG. 8, in some aspects, at 808, the UE 802 may perform timer expiration operations based on the first time alignment timer or the second time alignment timer. In some aspects, the UE 802 may perform TRP-level timer expiration operations in a serving cell related to a TRP if a time alignment timer corresponding to the TRP expires. For example, if the first time alignment timer expires, the UE 802 may perform TRP-level timer expiration associated with the first TRP 804A. If the second time alignment timer expires, the UE 802 may perform TRP-level timer expiration associated with the second TRP 804B. The TRP-level timer expiration operations may be performed individually for each TRP.

In some aspects, it may be more efficient to not cancel all the UL configurations associated with the TRP when a time alignment timer expires. In some aspects, when two TAGs are configured with individual time alignment timers in a BWP and/or CC configured with multi-DCI based mTRP operation, and the UE 802 performs TRP-level timer expiration operations in a serving cell related to a TRP if a time alignment timer corresponding to the TRP expires, the UE 802 may perform various operations.

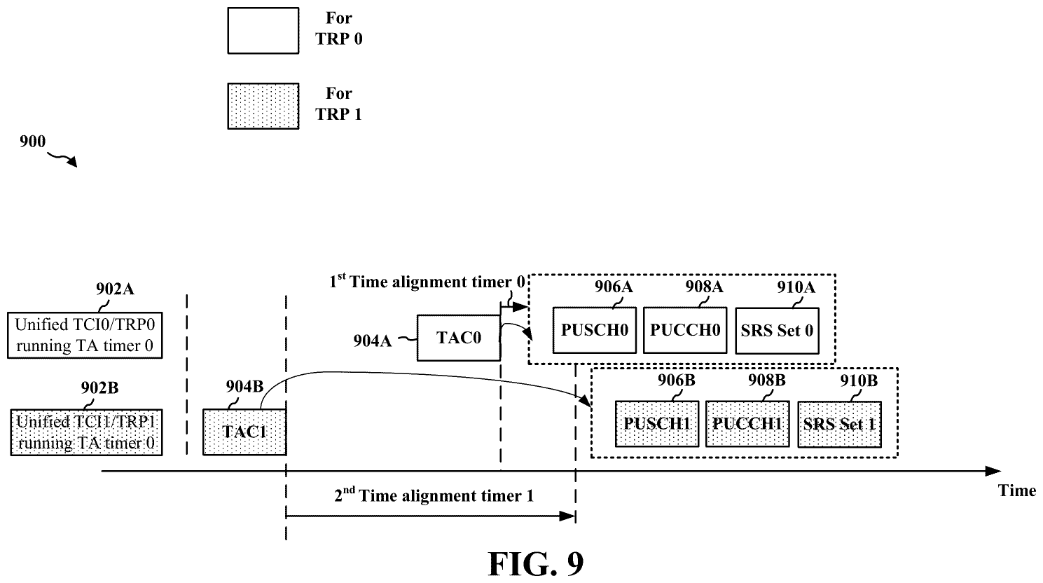

Referring to FIG. 9, FIG. 9 is a diagram 900 illustrating example time alignment timer communications in multi-TAG. As illustrated in FIG. 9, there may be a first running TA timer 902A (i.e., first running TA timer 0) associated with a first TRP (e.g., the TRP 804A) and a first unified TCI0. Upon receiving a timing advance command (TAC) 904A (i.e., TAC 0) associated with the first TRP, the UE 802 may start or reset the first time alignment timer. Upon expiration of the first time alignment timer, the UE 802 may accordingly suspend or release a PUSCH 906A, a PUCCH 908A, or an SRS set 910A associated with the first TRP (e.g., the TRP 804A). In some aspects, there may be second running TA timer 902B (i.e., second running TA timer 1) associated with a second TRP (e.g., the TRP 804B) and a second unified TCI1. Upon receiving a TAC 904B (i.e., TAC 1) associated with the second TRP, the UE 802 may start or reset the second time alignment timer. Upon expiration of the second time alignment timer, the UE 802 may accordingly suspend or release a PUSCH 906B, a PUCCH 908B, or an SRS set 910B associated with the second TRP.

In some aspects, the UE 802 may cancel higher layer configured UL configurations associated with the TRP (e.g., one of the first TRP 804A or the second TRP 804B) corresponding with the expired timer (e.g., the first time alignment timer or the second time alignment timer). For example, the higher layer configured UL configurations associated with the TRP may include a PUCCH for P-CSI. In some aspects, the higher layer configured UL configurations associated with the TRP may not be switched to the other TRP (e.g., other one of the first TRP 804A or the second TRP 804B).

In some aspects, the UE 802 may suspend semi-persistent UL transmissions or configurations associated with the TRP (e.g., one of the first TRP 804A or the second TRP 804B) corresponding with the expired timer (e.g., the first time alignment timer or the second time alignment timer). For example, the semi-persistent UL transmissions or configurations may include a PUCCH for SP-CSI, a PUSCH for SP-CSI, SP-SRS, and a CG2-PUSCH. In some aspects, the semi-persistent UL transmissions or configurations associated with the TRP may be switched to the other TRP (e.g., other one of the first TRP 804A or the second TRP 804B) based on new activating or scheduling signaling. For example, after the UE 802 suspends the transmission of a PUCCH for SP-CSI when the PUCCH has a TCI associated with a TRP or a TAG of an expired time alignment timer, the UE 802 may receive a new TCI indication to the PUCCH where the new indicated TCI may be associated with a new TRP or a new TAG of a running time alignment timer, and then the UE 802 may resume the transmission of the PUCCH for SP-CSI.

In some aspects, the TRP-level timer expiration operations at 808 may include one or more of: 1) flush all HARQ buffers associated with the TRP, 2) notify RRC to release a PUCCH associated with the TRP, if configured, 3) notify RRC to release SRS associated with the TRP, if configured, 4) clear configured downlink assignments and configured uplink grants associated with the TRP, 5) clear a PUSCH resource for semi-persistent CSI reporting associated with the TRP, 6) maintain N_{TA} of TAG associated with the TRP. In some aspects, the TRP-level timer expiration operations at 808 may be performed by a MAC entity at the UE.

In some aspects, the TRP-level timer expiration operations at 808 may include one or more of: 1) flush HARQ buffers associated with the TRP, 2) notify RRC to release a PUCCH associated with the TRP for P-CSI, if configured, 3) suspend a PUCCH associated with the TRP for SP-CSI, or A/N to SPS PDSCH, if configured, 4) suspend SP SRS associated with the TRP, if configured, 5) suspend any PUSCH resource for semi-persistent CSI reporting associated with the TRP, 6) suspend type2 configured uplink grants associated with the TRP, 7) clear configured downlink assignments and type1 configured uplink grants associated with the TRP, or 8) maintain N_{TA} of TAG associated with the TRP. In some aspects, the TRP-level timer expiration operations at 808 may be performed by a MAC entity at the UE.

In some aspects, the UE 802 may not expect to receive DCI scheduling UL transmission associated with the TRP (e.g., one of the first TRP 804A or the second TRP 804B) corresponding with the expired timer (e.g., the first time alignment timer or the second time alignment timer). For example, the UE 802 may not expect to receive DCI scheduling a PUSCH or a PUCCH associated with the TRP (e.g., one of the first TRP 804A or the second TRP 804B) corresponding with the expired timer (e.g., the first time alignment timer or the second time alignment timer).

In some aspects, upon expiration of the first time alignment timer or the second time alignment timer associated with a TRP, some RRC configured UL resources may be kept instead of released and may be rescheduled for the other TRP. As illustrated in FIG. 8, upon expiration of the first time alignment timer or the second time alignment timer, in some aspects, a DG PUCCH, a DG PUSCH, and aperiodic (AP) SRS may be based on scheduling DCI and may be suspended (e.g., as part of the operations at 808) until new DCI update. In some aspects, SP SRS, a PUCCH for SP-CSI and AN to SPS PDSCH, a PUSCH for SP-CSI, and a CG2 PUSCH may be based on an activating signaling (e.g., in DCI or a MAC-CE) and may be suspended (e.g., as part of the operations at 808) until new activation. In some aspects, a CG1 PUSCH and a PUCCH for P-CSI may be based on higher layer configuration (e.g., via RRC or a MAC-CE) and may be released (e.g., as part of the operations at 808) until a new configuration.

In some aspects, if one of the two TRPs (e.g., the first TRP 804A or the second TRP 804B) is associated with a serving cell and another one of the two TRPs (e.g., other one of the first TRP 804A or the second TRP 804B) is associated with a non-serving cell, and if the TRP associated with the serving cell is associated with a time alignment timer expiration, the UE may perform cell-level timer expiration operations.

In some aspects, if one of the two TRPs (e.g., the first TRP 804A or the second TRP 804B) is associated with a primary TAG and another one of the two TRPs (e.g., other one of the first TRP 804A or the second TRP 804B) is associated with a secondary TAG, and if the TRP associated with the primary TAG is associated with a time alignment timer expiration, the UE may perform cell-level timer expiration operations.

In some aspects, the UE 802 may perform cell-level timer expiration operations in a serving cell if any of the time alignment timer (e.g., the first time alignment timer or the second time alignment timer) expires. In some aspects, the cell-level timer expiration operations may include refraining from transmitting to both of the TRPs (except a PRACH) when at least one TRP is out of synchronization (i.e., out of sync) or not available for scheduling.

In some aspects, the UE 802 may perform cell-level timer expiration operations in a serving cell if both of the time alignment timer (e.g., the first time alignment timer or the second time alignment timer) expires. In some aspects, the UE 802 may perform periodical transmissions to a TRP out of synchronization (i.e., out of sync) before both TA timer expires.

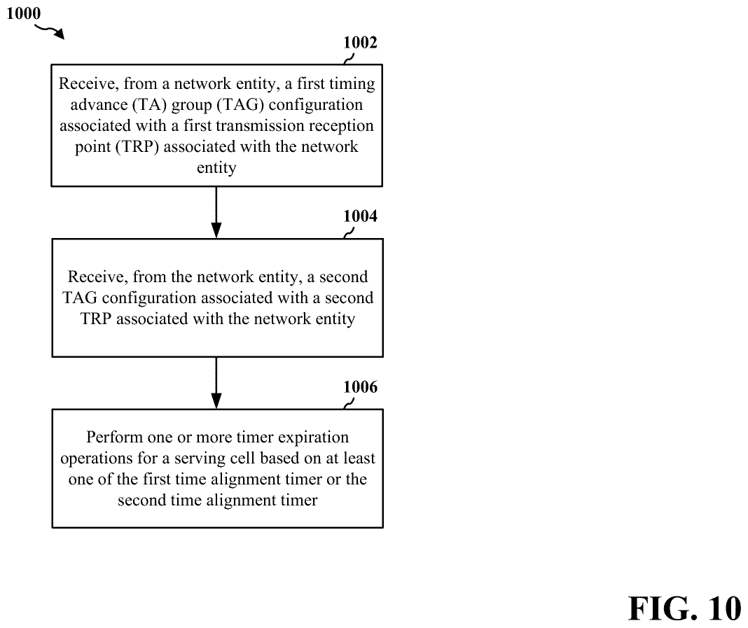

FIG. 10 is a flowchart 1000 of a method of wireless communication. The method may be performed by a UE (e.g., the UE 104, the UE 602/802; the apparatus 1204).

At 1002, the UE may receive, from a network entity, a first TAG configuration associated with a first TRP associated with the network entity. For example, the UE 802 may receive, from a network entity 804, a first TAG configuration 806A associated with a first TRP associated with the network entity. Further, 1002 may be performed by alignment component 198.

At 1004, the UE may receive, from the network entity, a second TAG configuration associated with a second TRP associated with the network entity. For example, the UE 802 may receive, from the network entity 804, a second TAG configuration 806B associated with a second TRP associated with the network entity. Further, 1004 may be performed by alignment component 198. In some aspects, the first TAG configuration and the second TAG configuration may be associated with a BWP or a CC. In some aspects, the first TAG configuration may be associated with a first time alignment timer and the second TAG configuration may be associated with a second time alignment timer.

At 1006, the UE may perform one or more timer expiration operations for a serving cell based on at least one of the first time alignment timer or the second time alignment timer. For example, the UE 802 may perform one or more timer expiration operations for a serving cell based on at least one of the first time alignment timer or the second time alignment timer at 808. Further, 1006 may be performed by alignment component 198. In some aspects, the serving cell may be associated with the first TRP, and the one or more timer expiration operations for the serving cell may be performed based on an expiration of the first time alignment timer that is independent of the second time alignment timer. In some aspects, the one or more timer expiration operations may include canceling one or more UL configurations associated with the TRP. In some aspects, the one or more UL configurations include one or more of: a first PUCCH for P-CSI, a second PUCCH for a scheduling request (SR), a P-SRS, a configured grant type 1 PUSCH (CG1-PUSCH), or a third PUCCH for acknowledgment/non-acknowledgment (A/N) to a SPS-PDSCH.

In some aspects, the one or more timer expiration operations include suspending one or more semi-persistent UL transmissions or one or more semi-persistent UL configurations associated with the TRP. In some aspects, the one or more semi-persistent UL transmissions or the one or more semi-persistent UL configurations may include one or more of: a PUCCH for SP-CSI, PUSCH for the SP-CSI or a SP-SRS, or a CG2-PUSCH.

In some aspects, the one or more timer expiration operations may include refraining from receiving DCI scheduling an UL transmission associated with the TRP. In some aspects, the UL transmission associated with the TRP may include a PUSCH or a PUCCH.

In some aspects, the one or more timer expiration operations for the serving cell may be performed based on a first expiration of the first time alignment timer or a second expiration of the second time alignment timer. In some aspects, the one or more timer expiration operations for the serving cell may be performed based on an expiration of the first time alignment timer and an expiration of the second time alignment timer.

In some aspects, the one or more timer expiration operations may include one or more of: flushing HARQ buffers associated with the first TRP or the second TRP, notifying a RRC to release a PUCCH associated with the first TRP or the second TRP, notifying the RRC to release a sounding reference signal (SRS) associated with the first TRP or the second TRP, clearing one or more configured DL assignments or one or more configured UL grants associated with the first TRP or the second TRP, clearing one or more physical uplink control channel (PUSCH) resources associated with the first TRP or the second TRP, or maintaining a TA associated with the first TAG configuration or the second TAG configuration.

In some aspects, the one or more timer expiration operations may include one or more of: flushing HARQ buffers associated with the first TRP or the second TRP, notifying a RRC to release a first PUCCH associated with the first TRP or the second TRP for P-CSI, suspending a second PUCCH for SP-CSI associated with the first TRP or the second TRP or a third PUCCH for A/N to a SPS-PDSCH associated with the first TRP or the second TRP, suspending a PUSCH for SP-CSI reporting associated with the first TRP or the second TRP, suspending one or more type 2 configured uplink grants associated with the first TRP or the second TRP, clearing one or more configured DL assignments or one or more type 1 configured UL grants associated with the first TRP or the second TRP, or suspending or maintaining a TA associated with the first TAG configuration or the second TAG configuration.

In some aspects, the first TRP may be associated with the serving cell and the second TRP is associated with a non-serving cell. In some aspects, the one or more timer expiration operations may include one or more cell-level operations. In some aspects, the one or more timer expiration operations may include maintaining one or more RRC configured UL resources.

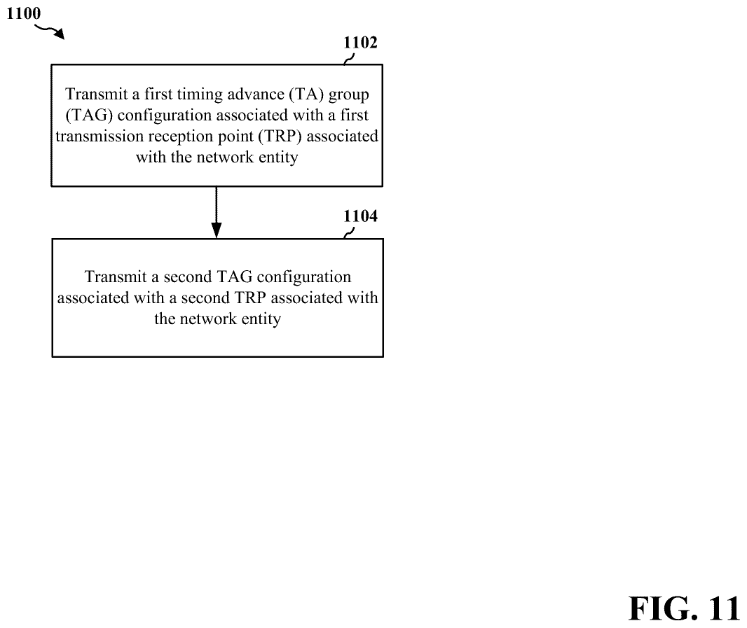

FIG. 11 is a flowchart 1100 of a method of wireless communication. The method may be performed by a network entity (e.g., the base station 102/180; the network entity 1202).

At 1102, the network entity may transmit a first TAG configuration associated with a first TRP associated with the network entity. For example, the network entity 804 may transmit a first TAG configuration 806A associated with a first TRP associated with the network entity. Further, 1102 may be performed by alignment component 199.

At 1104, the network entity may transmit a second TAG configuration associated with a second TRP associated with the network entity. For example, the network entity 804 may transmit a second TAG configuration 806B associated with a second TRP associated with the network entity. Further, 1104 may be performed by alignment component 199. In some aspects, the first TAG configuration and the second TAG configuration may be associated with a BWP or a CC. In some aspects, the first TAG configuration may be associated with a first time alignment timer and the second TAG configuration may be associated with a second time alignment timer. In some aspects, the first time alignment timer or the second time alignment timer may be associated with one or more timer expiration operations for a serving cell. In some aspects, the serving cell may be associated with the first TRP and the one or more timer expiration operations for the serving cell may be associated with an expiration of the first time alignment timer that is independent of the second time alignment timer. In some aspects, the one or more timer expiration operations for the serving cell may be associated with a first expiration of the first time alignment timer or a second expiration of the second time alignment timer. In some aspects the one or more timer expiration operations for the serving cell may be associated with an expiration of the first time alignment timer and an expiration of the second time alignment timer. In some aspects, the first TRP may be associated with the serving cell and the second TRP is associated with a non-serving cell. In some aspects, the one or more timer expiration operations may include one or more cell-level operations.

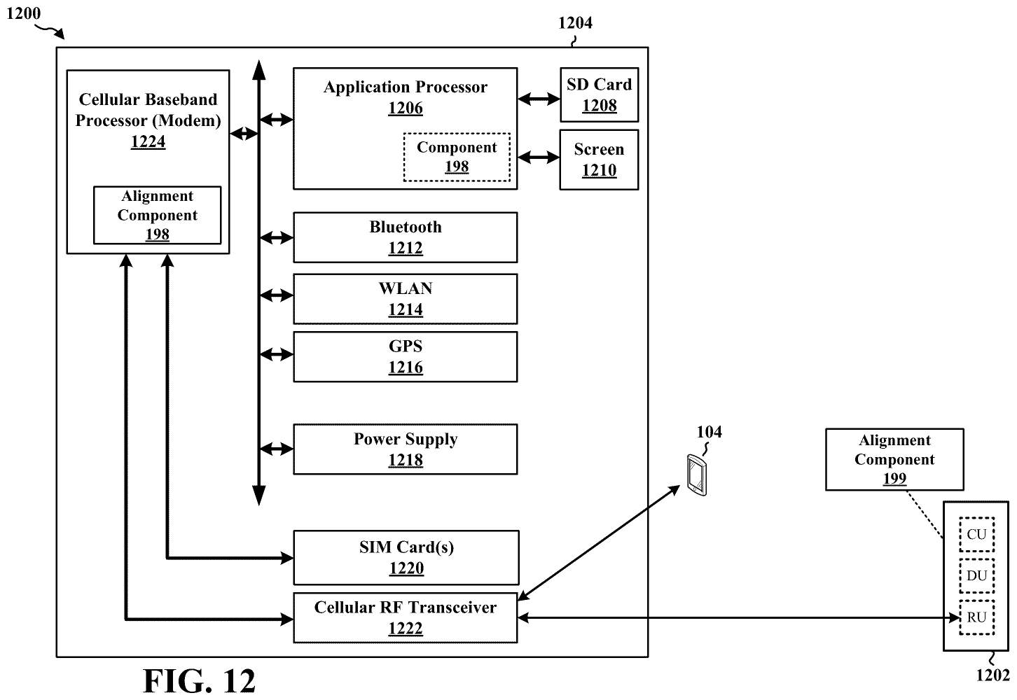

FIG. 12 is a diagram 1200 illustrating an example of a hardware implementation for an apparatus 1204 and a network entity 1202. The apparatus 1204 may be a UE, a component of a UE, or may implement UE functionality. The network entity 1202 may be a BS, a component of a BS, or may implement BS functionality. In some aspects, the apparatus 1204 may include a cellular baseband processor 1224 (also referred to as a modem) coupled to a cellular RF transceiver 1222. In some aspects, the apparatus 1204 may further include one or more subscriber identity modules (SIM) cards 1220, an application processor 1206 coupled to a secure digital (SD) card 1208 and a screen 1210, a Bluetooth module 1212, a wireless local area network (WLAN) module 1214, a Global Positioning System (GPS) module 1216, or a power supply 1218. The cellular baseband processor 1224 communicates through the cellular RF transceiver 1222 with the UE 104 and/or with an RU associated with the network entity 1202. The RU is either part of the network entity 1202 or is in communication with the network entity 1202. The network entity 1202 may include one or more of the CU, DU, and the RU. The cellular baseband processor 1224 and the application processor 1206 may each include a computer-readable medium/memory. Each computer-readable medium/memory may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see 350 of FIG. 3) and include the additional modules of the apparatus 1204.

As discussed supra, in some aspects, the alignment component 198 may be configured to receive, from a network entity, a first timing advance (TA) group (TAG) configuration associated with a first transmission reception point (TRP) associated with the network entity. In some aspects, the alignment component 198 may be further configured to receive, from the network entity, a second TAG configuration associated with a second TRP associated with the network entity, the first TAG configuration and the second TAG configuration being associated with a bandwidth part (BWP) or a component carrier (CC), the first TAG configuration being associated with a first time alignment timer and the second TAG configuration being associated with a second time alignment timer. In some aspects, the alignment component 198 may be further configured to perform one or more timer expiration operations for a serving cell based on at least one of the first time alignment timer or the second time alignment timer.

The alignment component 198 may be within the cellular baseband processor 1224, the application processor 1206, or both the cellular baseband processor 1224 and the application processor 1206. The alignment component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for receiving, from a network entity, a first timing advance (TA) group (TAG) configuration associated with a first transmission reception point (TRP) associated with the network entity. In some aspects, the cellular baseband processor 1224 and/or the application processor 1206 may further include means for receiving, from the network entity, a second TAG configuration associated with a second TRP associated with the network entity, the first TAG configuration and the second TAG configuration being associated with a bandwidth part (BWP) or a component carrier (CC), the first TAG configuration being associated with a first time alignment timer and the second TAG configuration being associated with a second time alignment timer. In some aspects, the cellular baseband processor 1224 and/or the application processor 1206 may further include means for performing one or more timer expiration operations for a serving cell based on at least one of the first time alignment timer or the second time alignment timer. In some aspects, the cellular baseband processor 1224 and/or the application processor 1206 may further include means for flushing hybrid automatic repeat request (HARQ) buffers associated with the first TRP or the second TRP. In some aspects, the cellular baseband processor 1224 and/or the application processor 1206 may further include means for notifying a radio resource control (RRC) to release a physical uplink control channel (PUCCH) associated with the first TRP or the second TRP. In some aspects, the cellular baseband processor 1224 and/or the application processor 1206 may further include means for notifying the RRC to release a sounding reference signal (SRS) associated with the first TRP or the second TRP. In some aspects, the cellular baseband processor 1224 and/or the application processor 1206 may further include means for clearing one or more configured downlink (DL) assignments or one or more configured uplink (UL) grants associated with the first TRP or the second TRP. In some aspects, the cellular baseband processor 1224 and/or the application processor 1206 may further include means for clearing one or more physical uplink control channel (PUSCH) resources associated with the first TRP or the second TRP. In some aspects, the cellular baseband processor 1224 and/or the application processor 1206 may further include means for maintaining a timing advance (TA) associated with the first TAG configuration or the second TAG configuration. In some aspects, the cellular baseband processor 1224 and/or the application processor 1206 may further include means for flushing hybrid automatic repeat request (HARQ) buffers associated with the first TRP or the second TRP. In some aspects, the cellular baseband processor 1224 and/or the application processor 1206 may further include means for notifying a radio resource control (RRC) to release a first physical uplink control channel (PUCCH) associated with the first TRP or the second TRP for periodic channel state information (P-CSI). In some aspects, the cellular baseband processor 1224 and/or the application processor 1206 may further include means for suspending a second PUCCH for semi-persistent channel state information (SP-CSI) associated with the first TRP or the second TRP or a third PUCCH for acknowledgment or non-acknowledgment (A/N) to a semi-persistent scheduling (SPS) physical downlink shared channel (SPS-PDSCH) associated with the first TRP or the second TRP. In some aspects, the cellular baseband processor 1224 and/or the application processor 1206 may further include means for suspending a physical uplink shared channel (PUSCH) for SP-CSI reporting associated with the first TRP or the second TRP. In some aspects, the cellular baseband processor 1224 and/or the application processor 1206 may further include means for suspending one or more type 2 configured uplink grants associated with the first TRP or the second TRP. In some aspects, the cellular baseband processor 1224 and/or the application processor 1206 may further include means for clearing one or more configured downlink (DL) assignments or one or more type 1 configured uplink (UL) grants associated with the first TRP or the second TRP. In some aspects, the cellular baseband processor 1224 and/or the application processor 1206 may further include means for suspending or maintaining a timing advance (TA) associated with the first TAG configuration or the second TAG configuration.

The means may be the component 198 of the apparatus 1204 configured to perform the functions recited by the means. As described supra, the apparatus 1204 may include the TX Processor 368, the RX Processor 356, and the controller/processor 359. As such, in one configuration, the means may be the TX Processor 368, the RX Processor 356, and/or the controller/processor 359 configured to perform the functions recited by the means.

As discussed supra, in some aspects, the alignment component 199 may be configured to transmit a first timing advance (TA) group (TAG) configuration associated with a first transmission reception point (TRP) associated with the network entity. In some aspects, the alignment component 199 may be further configured to transmit a second TAG configuration associated with a second TRP associated with the network entity, the first TAG configuration and the second TAG configuration being associated with a bandwidth part (BWP) or a component carrier (CC), the first TAG configuration being associated with a first time alignment timer and the second TAG configuration being associated with a second time alignment timer. In some aspects, at least one of the first time alignment timer or the second time alignment timer is associated with one or more timer expiration operations for a serving cell. The alignment component 199 may be within one or more processors (e.g., BBU(s)) of one or more of the CU, DU, and the RU. The alignment component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 includes means for transmitting a first timing advance (TA) group (TAG) configuration associated with a first transmission reception point (TRP) associated with the network entity. The network entity 1202 may further include means for transmitting a second TAG configuration associated with a second TRP associated with the network entity. The means may be the component 199 of the network entity 1202 configured to perform the functions recited by the means. As described supra, the network entity 1202 may include the TX Processor 316, the RX Processor 370, and the controller/processor 375. As such, in one configuration, the means may be the TX Processor 316, the RX Processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used in this disclosure outside of the claims, the phrase “based on” is inclusive of all interpretations and shall not be limited to any single interpretation unless specifically recited or indicated as such. For example, the phrase “based on A” (where “A” may be information, a condition, a factor, or the like) may be interpreted as: “based at least on A,” “based in part on A,” “based at least in part on A,” “based only on A,” or “based solely on A.” Accordingly, as disclosed herein, “based on A” may, in one aspect, refer to “based at least on A.” In another aspect, “based on A” may refer to “based in part on A.” In another aspect, “based on A” may refer to “based at least in part on A.” In another aspect, “based on A” may refer to “based only on A.” In another aspect, “based on A” may refer to “based solely on A.” In another aspect, “based on A” may refer to any combination of interpretations in the alternative. As used in the claims, the phrase “based on A” shall be interpreted as “based at least on A” unless specifically recited differently.

The following aspects are illustrative only and may be combined with other aspects or teachings described herein, without limitation.
Aspect 1 is a method of communication at a user equipment (UE), including: memory; and at least one processor coupled to the memory and configured to: receiving, from a network entity, a first timing advance (TA) group (TAG) configuration associated with a first transmission reception point (TRP) associated with the network entity; receiving, from the network entity, a second TAG configuration associated with a second TRP associated with the network entity, the first TAG configuration and the second TAG configuration being associated with a bandwidth part (BWP) or a component carrier (CC), the first TAG configuration being associated with a first time alignment timer and the second TAG configuration being associated with a second time alignment timer; and performing one or more timer expiration operations for a serving cell based on at least one of the first time alignment timer or the second time alignment timer.
Aspect 2 is the method of aspect 1, where the serving cell is associated with the first TRP, and where the one or more timer expiration operations for the serving cell are performed based on an expiration of the first time alignment timer that is independent of the second time alignment timer.
Aspect 3 is the method of any of aspects 1-2, where the one or more timer expiration operations include canceling one or more uplink (UL) configurations associated with the TRP.
Aspect 4 is the method of any of aspects 1-3, where the one or more UL configurations include one or more of: a first physical uplink control channel (PUCCH) for periodic channel state information (P-CSI), a second PUCCH for a scheduling request (SR), a periodic sounding reference signal (P-SRS), a configured grant (CG) one physical uplink shared channel (CG1-PUSCH), or a third PUCCH for acknowledgment or non-acknowledgment (A/N) to a semi-persistent scheduling (SPS) physical downlink shared channel (SPS-PDSCH).
Aspect 5 is the method of any of aspects 1-4, where the one or more timer expiration operations include suspending one or more semi-persistent uplink (UL) transmissions or one or more semi-persistent UL configurations associated with the TRP.
Aspect 6 is the method of any of aspects 1-5, where the one or more semi-persistent UL transmissions or the one or more semi-persistent UL configurations include one or more of: a physical uplink control channel (PUCCH) for semi-persistent channel state information (SP-CSI), a physical uplink shared channel (PUSCH) for the SP-CSI or a semi-persistent sounding reference signal (SP-SRS), or a configured grant (CG) two physical uplink shared channel (CG2-PUSCH).
Aspect 7 is the method of any of aspects 1-6, where the one or more timer expiration operations include refraining from receiving downlink control information (DCI) scheduling an uplink (UL) transmission associated with the TRP.
Aspect 8 is the method of any of aspects 1-7, where the UL transmission associated with the TRP includes a physical uplink shared channel (PUSCH) or a physical uplink control channel (PUCCH).
Aspect 9 is the method of any of aspects 1, 3-8, where the one or more timer expiration operations for the serving cell are performed based on a first expiration of the first time alignment timer or a second expiration of the second time alignment timer.
Aspect 10 is the method of any of aspects 1, 3-8, where the one or more timer expiration operations for the serving cell are performed based on an expiration of the first time alignment timer and an expiration of the second time alignment timer.
Aspect 11 is the method of any of aspects 1-10, where the one or more timer expiration operations include one or more of: flushing hybrid automatic repeat request (HARQ) buffers associated with the first TRP or the second TRP, notifying a radio resource control (RRC) to release a physical uplink control channel (PUCCH) associated with the first TRP or the second TRP, notifying the RRC to release a sounding reference signal (SRS) associated with the first TRP or the second TRP, clearing one or more configured downlink (DL) assignments or one or more configured uplink (UL) grants associated with the first TRP or the second TRP, clearing one or more physical uplink control channel (PUSCH) resources associated with the first TRP or the second TRP, or maintaining a timing advance (TA) associated with the first TAG configuration or the second TAG configuration.
Aspect 12 is the method of any of aspects 1-10, where the one or more timer expiration operations include one or more of: flushing hybrid automatic repeat request (HARQ) buffers associated with the first TRP or the second TRP, notifying a radio resource control (RRC) to release a first physical uplink control channel (PUCCH) associated with the first TRP or the second TRP for periodic channel state information (P-CSI), suspending a second PUCCH for semi-persistent channel state information (SP-CSI) associated with the first TRP or the second TRP or a third PUCCH for acknowledgment or non-acknowledgment (A/N) to a semi-persistent scheduling (SPS) physical downlink shared channel (SPS-PDSCH) associated with the first TRP or the second TRP, suspending a physical uplink shared channel (PUSCH) for SP-CSI reporting associated with the first TRP or the second TRP, suspending one or more type 2 configured uplink grants associated with the first TRP or the second TRP, clearing one or more configured downlink (DL) assignments or one or more type 1 configured uplink (UL) grants associated with the first TRP or the second TRP, or suspending or maintaining a timing advance (TA) associated with the first TAG configuration or the second TAG configuration.
Aspect 13 is the method of any of aspects 1-12, where the first TRP is associated with the serving cell and the second TRP is associated with a non-serving cell, and where the one or more timer expiration operations include one or more cell-level operations.
Aspect 14 is the method of aspect 1-13, where the one or more timer expiration operations include maintaining one or more radio resource control (RRC) configured uplink (UL) resources.
Aspect 15 is the method of any of aspects 1-14, where the method is performed at an apparatus including at least one of a transceiver or an antenna coupled to the at least one processor.
Aspect 16 is a method of communication at a network entity, including: transmitting a first timing advance (TA) group (TAG) configuration associated with a first transmission reception point (TRP) associated with the network entity; and transmitting a second TAG configuration associated with a second TRP associated with the network entity, the first TAG configuration and the second TAG configuration being associated with a bandwidth part (BWP) or a component carrier (CC), the first TAG configuration being associated with a first time alignment timer and the second TAG configuration being associated with a second time alignment timer, where at least one of the first time alignment timer or the second time alignment timer is associated with one or more timer expiration operations for a serving cell.
Aspect 17 is the method of aspect 16, where the serving cell is associated with the first TRP, and where the one or more timer expiration operations for the serving cell are associated with an expiration of the first time alignment timer that is independent of the second time alignment timer.
Aspect 18 is the method of any of aspects 16-17, where the one or more timer expiration operations for the serving cell are associated with a first expiration of the first time alignment timer or a second expiration of the second time alignment timer.
Aspect 19 is the method of any of aspects 16-18, where the one or more timer expiration operations for the serving cell are associated with an expiration of the first time alignment timer and an expiration of the second time alignment timer.
Aspect 20 is the method of any of aspects 16-19, where the first TRP is associated with the serving cell and the second TRP is associated with a non-serving cell, and where the one or more timer expiration operations include one or more cell-level operations.
Aspect 21 is the method of any of aspects 16-20, where the method is performed at an apparatus including at least one of a transceiver or an antenna coupled to the at least one processor.
Aspect 22 is an apparatus for wireless communication at a UE including a memory including instructions and at least one processor coupled to the memory and configured to execute the instructions and cause the apparatus to perform a method in accordance with any of aspects 1-15.
Aspect 23 is an apparatus for wireless communications, including means for performing a method in accordance with any of aspects 1-15.
Aspect 24 is a non-transitory computer-readable medium including instructions that, when executed by an apparatus, cause the apparatus to perform a method in accordance with any of aspects 1-14.
Aspect 25 is an apparatus for wireless communication at a network entity including a memory including instructions and at least one processor coupled to the memory and configured to execute the instructions and cause the apparatus to perform a method in accordance with any of aspects 16-21.
Aspect 26 is an apparatus for wireless communications, including means for performing a method in accordance with any of aspects 16-21.
Aspect 27 is a non-transitory computer-readable medium including instructions that, when executed by an apparatus, cause the apparatus to perform a method in accordance with any of aspects 16-21.

What is claimed is:

1. An apparatus for communication at a user equipment (UE), comprising:
memory; and
at least one processor coupled to the memory and configured to:
receive, from a network entity, a first timing advance (TA) group (TAG) configuration associated with a first transmission reception point (TRP) associated with the network entity;
receive, from the network entity, a second TAG configuration associated with a second TRP associated with the network entity, the first TAG configuration and the second TAG configuration being associated with a bandwidth part (BWP) or a component carrier (CC), the first TAG configuration being associated with a first time alignment timer and the second TAG configuration being associated with a second time alignment timer; and
perform one or more timer expiration operations for a serving cell based on at least one of the first time alignment timer or the second time alignment timer.

2. The apparatus of claim 1, wherein the serving cell is associated with the first TRP, and wherein the one or more timer expiration operations for the serving cell are performed based on an expiration of the first time alignment timer that is independent of the second time alignment timer.

3. The apparatus of claim 2, wherein the one or more timer expiration operations comprise canceling one or more uplink (UL) configurations associated with the TRP.

4. The apparatus of claim 3, wherein the one or more UL configurations comprise one or more of: a first physical uplink control channel (PUCCH) for periodic channel state information (P-CSI), a second PUCCH for a scheduling request (SR), a periodic sounding reference signal (P-SRS), a configured grant (CG) one physical uplink shared channel (CG1-PUSCH), or a third PUCCH for acknowledgment or non-acknowledgment (A/N) to a semi-persistent scheduling (SPS) physical downlink shared channel (SPS-PDSCH).

5. The apparatus of claim 2, wherein the one or more timer expiration operations comprise suspending one or more semi-persistent uplink (UL) transmissions or one or more semi-persistent UL configurations associated with the TRP.

6. The apparatus of claim 5, wherein the one or more semi-persistent UL transmissions or the one or more semi-persistent UL configurations comprise one or more of: a physical uplink control channel (PUCCH) for semi-persistent channel state information (SP-CSI), a physical uplink shared channel (PUSCH) for the SP-CSI or a semi-persistent sounding reference signal (SP-SRS), or a configured grant (CG) two physical uplink shared channel (CG2-PUSCH).

7. The apparatus of claim 2, wherein the one or more timer expiration operations comprise refraining from receiving downlink control information (DCI) scheduling an uplink (UL) transmission associated with the TRP.

8. The apparatus of claim 7, wherein the UL transmission associated with the TRP comprises a physical uplink shared channel (PUSCH) or a physical uplink control channel (PUCCH).

9. The apparatus of claim 1, wherein the one or more timer expiration operations for the serving cell are performed based on a first expiration of the first time alignment timer or a second expiration of the second time alignment timer.

10. The apparatus of claim 1, wherein the one or more timer expiration operations for the serving cell are performed based on an expiration of the first time alignment timer and an expiration of the second time alignment timer.

11. The apparatus of claim 1, wherein the one or more timer expiration operations comprise one or more of:
flushing hybrid automatic repeat request (HARQ) buffers associated with the first TRP or the second TRP,
notifying a radio resource control (RRC) to release a physical uplink control channel (PUCCH) associated with the first TRP or the second TRP,
notifying the RRC to release a sounding reference signal (SRS) associated with the first TRP or the second TRP,
clearing one or more configured downlink (DL) assignments or one or more configured uplink (UL) grants associated with the first TRP or the second TRP,
clearing one or more physical uplink control channel (PUSCH) resources associated with the first TRP or the second TRP, or
maintaining a timing advance (TA) associated with the first TAG configuration or the second TAG configuration.

12. The apparatus of claim 1, wherein the one or more timer expiration operations comprise one or more of:
flushing hybrid automatic repeat request (HARQ) buffers associated with the first TRP or the second TRP,
notifying a radio resource control (RRC) to release a first physical uplink control channel (PUCCH) associated with the first TRP or the second TRP for periodic channel state information (P-CSI),
suspending a second PUCCH for semi-persistent channel state information (SP-CSI) associated with the first TRP or the second TRP or a third PUCCH for acknowledgment or non-acknowledgment (A/N) to a semi-persistent scheduling (SPS) physical downlink shared channel (SPS-PDSCH) associated with the first TRP or the second TRP,
suspending a physical uplink shared channel (PUSCH) for SP-CSI reporting associated with the first TRP or the second TRP,
suspending one or more type 2 configured uplink grants associated with the first TRP or the second TRP,
clearing one or more configured downlink (DL) assignments or one or more type 1 configured uplink (UL) grants associated with the first TRP or the second TRP, or
suspending or maintaining a timing advance (TA) associated with the first TAG configuration or the second TAG configuration.

13. The apparatus of claim 1, wherein the first TRP is associated with the serving cell and the second TRP is associated with a non-serving cell, and wherein the one or more timer expiration operations comprise one or more cell-level operations.

14. The apparatus of claim 1, wherein the one or more timer expiration operations comprise maintaining one or more radio resource control (RRC) configured uplink (UL) resources.

15. The apparatus of claim 1, further comprising at least one of a transceiver or an antenna coupled to the at least one processor.

16. An apparatus for communication at a network entity, comprising:
memory; and
at least one processor coupled to the memory and configured to:
transmit a first timing advance (TA) group (TAG) configuration associated with a first transmission reception point (TRP) associated with the network entity; and
transmit a second TAG configuration associated with a second TRP associated with the network entity, the first TAG configuration and the second TAG configuration being associated with a bandwidth part (BWP) or a component carrier (CC), the first TAG configuration being associated with a first time alignment timer and the second TAG configuration being associated with a second time alignment timer, wherein at least one of the first time alignment timer or the second time alignment timer is associated with one or more timer expiration operations for a serving cell.

17. The apparatus of claim 16, wherein the serving cell is associated with the first TRP, and wherein the one or more timer expiration operations for the serving cell are associated with an expiration of the first time alignment timer that is independent of the second time alignment timer.

18. The apparatus of claim 16, wherein the one or more timer expiration operations for the serving cell are associated with a first expiration of the first time alignment timer or a second expiration of the second time alignment timer.

19. The apparatus of claim 16, wherein the one or more timer expiration operations for the serving cell are associated with an expiration of the first time alignment timer and an expiration of the second time alignment timer.

20. The apparatus of claim 16, wherein the first TRP is associated with the serving cell and the second TRP is associated with a non-serving cell, and wherein the one or more timer expiration operations comprise one or more cell-level operations.

21. The apparatus of claim 16, further comprising at least one of a transceiver or an antenna coupled to the at least one processor.

22. A method of communication at a user equipment (UE), comprising:
receiving, from a network entity, a first timing advance (TA) group (TAG) configuration associated with a first transmission reception point (TRP) associated with the network entity;
receiving, from the network entity, a second TAG configuration associated with a second TRP associated with the network entity, the first TAG configuration and the second TAG configuration being associated with a bandwidth part (BWP) or a component carrier (CC), the first TAG configuration being associated with a first time alignment timer and the second TAG configuration being associated with a second time alignment timer; and
performing one or more timer expiration operations for a serving cell based on at least one of the first time alignment timer or the second time alignment timer.

23. The method of claim 22, wherein the serving cell is associated with the first TRP, and wherein the one or more timer expiration operations for the serving cell are performed based on an expiration of the first time alignment timer that is independent of the second time alignment timer.

24. The method of claim 23, wherein the one or more timer expiration operations comprise canceling one or more uplink (UL) configurations associated with the TRP.

25. The method of claim 24, wherein the one or more UL configurations comprise one or more of: a first physical uplink control channel (PUCCH) for periodic channel state information (P-CSI), a second PUCCH for a scheduling request (SR), a periodic sounding reference signal (P-SRS), a configured grant (CG) one physical uplink shared channel (CG1-PUSCH), or a third PUCCH for acknowledgment or non-acknowledgment (A/N) to a semi-persistent scheduling (SPS) physical downlink shared channel (SPS-PDSCH).

26. The method of claim 23, wherein the one or more timer expiration operations comprise suspending one or more semi-persistent uplink (UL) transmissions or one or more semi-persistent UL configurations associated with the TRP.

27. The method of claim 26, wherein the one or more semi-persistent UL transmissions or the one or more semi-persistent UL configurations comprise one or more of: a physical uplink control channel (PUCCH) for semi-persistent channel state information (SP-CSI), a physical uplink shared channel (PUSCH) for the SP-CSI or a semi-persistent sounding reference signal (SP-SRS), or a configured grant (CG) two physical uplink shared channel (CG2-PUSCH).

28. The method of claim 23, wherein the one or more timer expiration operations comprise refraining from receiving downlink control information (DCI) scheduling an uplink (UL) transmission associated with the TRP.

29. The method of claim 28, wherein the UL transmission associated with the TRP comprises a physical uplink shared channel (PUSCH) or a physical uplink control channel (PUCCH).

30. A method of communication at a network entity, comprising:
transmitting a first timing advance (TA) group (TAG) configuration associated with a first transmission reception point (TRP) associated with the network entity; and
transmitting a second TAG configuration associated with a second TRP associated with the network entity, the first TAG configuration and the second TAG configuration being associated with a bandwidth part (BWP) or a component carrier (CC), the first TAG configuration being associated with a first time alignment timer and the second TAG configuration being associated with a second time alignment timer, wherein at least one of the first time alignment timer or the second time alignment timer is associated with one or more timer expiration operations for a serving cell.
